(19) United States
(12) Patent Application Publication
(10) Pub. No.: US 2007/0181662 A1
(43) Pub. Date: Aug. 9, 2007

(54) Mail box

(76) Inventors: Anna-Karin Satherblom, Stockholm (SE); Fariboz Darbahani, Arsta (SE); Robin Edvardsson, Stockholm (SE); Ronny Johannesson, Huddinge (SE); Peter Johansson, Bromma (SE); Mattias Nordmark, Vagnharad (SE)

Correspondence Address: POTOMAC PATENT GROUP, PLLC, P. O. BOX 270, FREDERICKSBURG, VA, 22404, US

(21) Appl. No.: 10/547,836

(22) PCT Filed: Mar. 4, 2004
(86) PCT No.: PCT/SE04/00319

§ 371 Date: Nov. 28, 2006

(30) Foreign Application Priority Data
Mar. 4, 2003 (SE) 0300585-7

(51) Int. Cl. B65G 11/04

(52) U.S. Cl. 232/45

(57) ABSTRACT

A mail box has a lockable, controlled door or lid, person identifying means such as a card reader for electronic cards of type Smartcard and a key set for entering a personal code. After the mail box has received valid identifying information of a person, the door is automatically opened and a letter can be put into the mail box. In the mail box a marking means is provided that applies a marking to the letter that has been put in. The marking includes the identity of the person and information about the mail box and the time when the letter was put into the box. The mail box can also allow that registered or certified items of mail are put in and then receipts are printed. It can also allow stamping of items of mail put into the box by deducting a postage amount from a balance stored on the card and printing of a receipt for a received item and the payment made. The fact that only persons who can safely identify themselves can enter items of mail generally gives an enhanced security in handling mail. The marking on the letter also gives a possibility of tracking the sender of non-desired mail and of automatically monitoring the transport of the letter to the addressee.

### RELATED APPLICATION

This application claims priority and benefit from Swedish patent application No. 0300585-7, filed Mar. 4, 2003, the entire teachings of which are incorporated herein by reference.

### TECHNICAL FIELD

The present invention relates to a mail box for receiving mail from the public.

### BACKGROUND

When transporting letters and other mail using the public postal services it is generally not possible to associate a sent letter with the sender thereof. Information about the sender can in some cases be indicated on the letter but there is no guarantee that this information is correct. Thus, articles which are posted by being put into a public mail box are in principle anonymous. Therefore, for example letters containing threats to persons can in a simple way be sent to any person without any great risk that it will be possible to track or discover the sender.

Items of mail transported by the public postal services have also, at some occasions, been used to more or less damage, in a physical or medical way, the receiver, such as letters containing explosives, poisons, biological weapons and infectious substances. Hence, in order to increase the security, there may for such letters exist a need for information about the person who has sent the respective letter.

Another problem related to mail handling of today is that prepaying of items of mail is made by providing them with prepayment signs of various kinds such as postage stamps and directly stamped markings, before the respective mail item is put into a mail box.

In published European patent application 0 692 212 a mail box is disclosed in which pulling-in and stamping mechanisms are provided for, when putting mail items into it, directly stamp them including some indication of time and the receiving post office district or similar information, so that this operation thus does not have to be made separately in for example a sorting station. The franking machines disclosed in published European patent application 0 788 078 and 0 732 673 and the handling systems according to published U.S. patent application 2002/0083022 and published International patent application 97/40600 include different systems for identifying a user or sender.

### SUMMARY OF THE INVENTION

It is an object of the invention to provide a mail box that includes a possibility of identifying the person who has put a mail item into the mail box.

It is another object of the invention to provide a mail box including markings made on mail items put into the mail box.

It is another object of the invention to provide a mail box by means of which prepayment by stamping mail items can be executed at and by the mail box.

Generally, the mail box includes a lockable lid and some identifying device for identifying a person. The identifying device can be designed to for example read personal characteristics such as fingerprints, eye bottom structure and similar things and/or to receive entered personal codes comprising character sequences and/or to read an identity stored on some personal identity document or item. In particular, the mail box can include a card reader for reading an identity stored on an identity document or similar thing, in the preferred case an electronic card of the type Smartcard. All persons/companies/institutions or similar entities that are intended to have access to the mail box must be able to identifying themselves in a valid way. Particularly they must possess a readable card having a unique identity and preferably a code associated with the card. After the mail box has received valid identifying information, in the particular case after a card has been read by the card reader and further identifying information has been entered, the lid is automatically opened and a letter can be put into the mail box. Further, the mail box includes a stamping device or similar thing, herein called marking device, that places a mark or marking on the letter put into the box. The marking includes the identity of the person, the valid identity of whom has been received, in the special case the person, by means of the card of whom the lid was opened, and can in addition for example include information of the identity of the mail box itself such as its geographical position and the time when the letter was put into to the box. Information about the introduction of the letter into the mail box, such as the identity of the person putting it into the box or the identity which has been displayed the mail box for the identifying, the identity of the mail box and the time for putting the letter into the box, can be transferred to some central monitoring unit in order to for example follow the transport of the letter or for checking that the letter, without any danger for the addressee, can be opened by the addressee.

Thus, a letter is introduced in to the opening of the mail box, where elastically mounted rolls are brought in contact with the letter and pulls the letter into a first department of the box. This procedure insures that only one mail item can at a time be introduced. After the pulling-in operation the letter passes a marking station in which the marking is made. Thereupon, the letter is transferred to a collecting portion of the mail box, such as by opening a suitably located lid.

Advantageously, the mail box is provided with a graphical display which provides the person who has put the letter into the box with information that can be necessary in the putting-in procedure.

The mail box can have the following main functions all of which, however, have not to be provided:

Identifying the person who has put a mail item into the mail box.

Marking of mail items put into the box, both in regard of the person how has put the mail item into the box and in regard of possible payment received for the mail item.

Allowing paying for mail items put into the box.

Printing a receipt for a received mail item/payment received for a mail item.

Generally, the mail box provides an increased security.

The mail box can in special embodiments also provide advantages including that prepayment/stamping can be made directly at the mail box and that mailing of ESS-letters, i.e. registered letters, can be made directly in the mail box without any participation of a service person in a post office.

Additional objects and advantages of the invention will be set forth in the description which follows, and in part will be obvious from the description, or may be learned by practice of the invention. The objects and advantages of the invention may be realized and obtained by means of the methods, processes, instrumentalities and combinations particularly pointed out in the appended claims.

### BRIEF DESCRIPTION OF THE DRAWINGS

While the novel features of the invention are set forth with particularly in the appended claims, a complete understanding of the invention, both as to organization and content, and of the above and other features thereof may be gained from and the invention will be better appreciated from a consideration of the following detailed description of non-limiting embodiments presented hereinbelow with reference to the accompanying drawings, in which:

FIG. 1 is a perspective view of a mail box,

FIG. 2 is front view of the mail box of FIG. 1,

FIG. 3 is a cross-sectional view of s pulling-in and marking module mounted in the mail box of FIG. 1, and

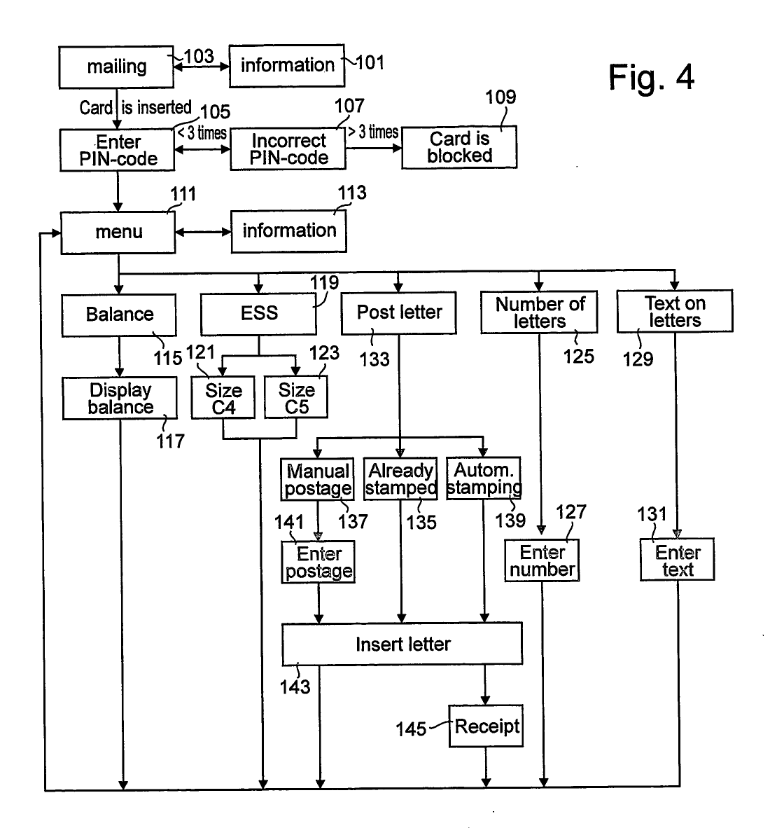

FIG. 4 is a flow diagram of different steps executed when putting a letter into a mail box according to FIG. 1, and

FIG. 5 and 6 are schematic cross sectional views of two different embodiments of a mail collection vessel.

### DETAILED DESCRIPTION

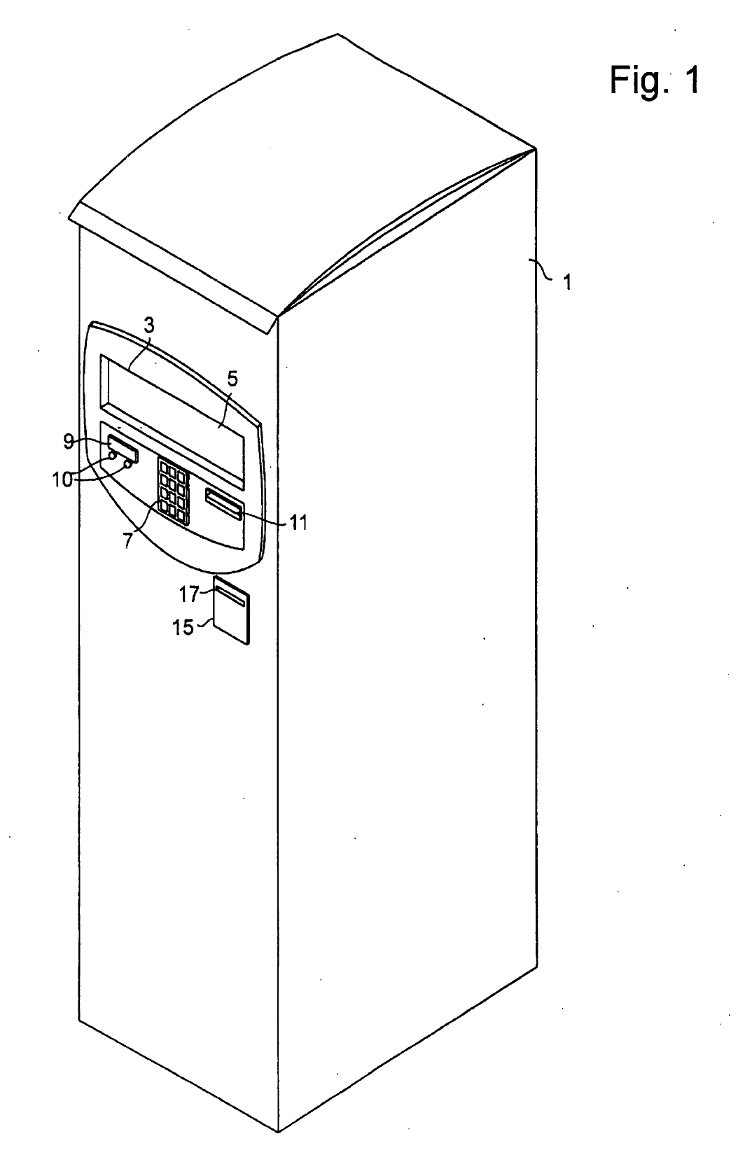

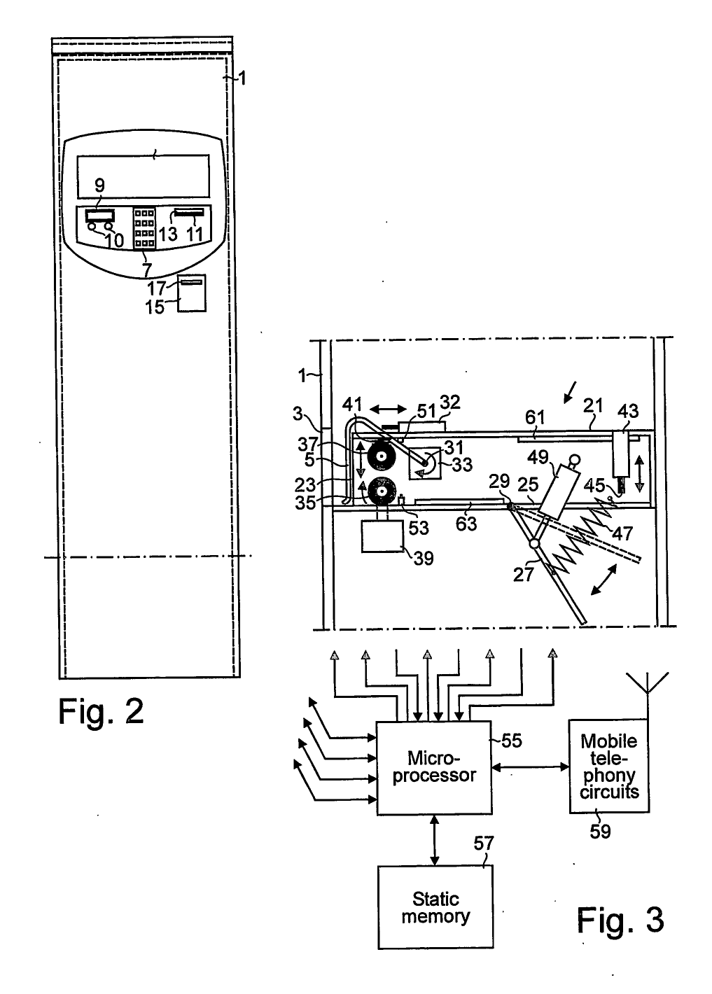

In FIG. 1 a mail box 1 for receiving mail items from the public is disclosed. The mail box includes on its front side, see also the view of FIG. 2, a feeding slot 3 having a lid 5, a key set 7 placed centrally beneath the slot, a display 9 placed at the left of the key set including two display buttons or keys 10 placed beneath it, a card reader 11 placed at the left of the key set including a feeding slot 13 for an electronic or magnetic card, and a receipt printer 15 having an output slot 17.

A lid 5 in the input slot belongs to a pulling-in and marking module 9 that is mounted completely inside the outer walls of the mail box 1. The module includes a relatively low rectangular box 21 having an open front surface 23, normally covered by the front lid 5, and having an opening 25 is its bottom surface. This opening is located in the rear inner portion of the module box and extends up to the rear inner wall of the module box. The bottom opening 25 is normally closed by a bottom lid 27 that at a hinge 29 is articulated at the bottom of the module box 21, at the front edge of the bottom opening 25 that is located at a distance from the open front surface 23 of the module box.

The front lid 5 is mounted to swing about pivoting points 31 placed on the side or lateral surfaces of the module box so that the front lid can be moved from the normal, swung-down position in which it closes both the introduction slot 3 of the mail box and the open front surface of the module box 21 to a swung-up position in which the introduction slot and the front surface 23 respectively are open, so that a mail item can be put into the module box. An electrically operated locking device 32 for the lid 5 normally locks the lid in its closed position and can as illustrated include a solenoid placed on the upper side of the module box 21. Furthermore, the lid 5 can, commanded by electrical signals, be moved from the closed position to the swung-up, opened position and back again by a motor 33.

Inside the front surface, within the module box, lower and upper pulling-in rolls 35, 37 are provided which have horizontal axes, i.e. axes located parallel to the longitudinal direction of the slot 3, and can be the type which is used for pulling-in/feeding-out paper in common copying machines and computer printers. The pulling-in rolls are elastically biased so that they press in directions towards each other. They can both or at least the upper ones be rotatably mounted at ends of moveable arms, such as pivoting arms, not shown, that are mounted at the box 21. For example the lower pulling-in rolls can be driven by an electric motor 39 for pulling a mail item further into the module box. At least the upper pulling-in rolls 37 are elastically biased such as by springs 41.

At a relatively short distance from the rear wall of the modular box 21 a marking or stamping unit 43 is mounted including printing machinery having a bottom printing surface 45. The printing surface can be designed as a simple pen or it can be part of an electrically controlled printing unit, either of mechanical type or of ink jet type. In the case of a printing unit the difference signs which are placed on a mail item can be set as commanded by electrical signals. In the case of a pen it can, also commanded by electrical signals, be brought down to place a marking on a mail item put into the box. The marking is placed when a mail item is positioned in contact with the rear inner end surface of the box. The marking unit can be mounted on a carriage, not shown, that is mounted to a slide in the transverse direction of the module box, along a rail, not shown, and that thereby can be displaced to different transverse positions by a motor, not shown, provided with a driving toothed wheel cooperating with a toothed belt attached to the carriage.

The bottom lid 27 is normally swung-up so that it forms a portion or continuation of the bottom of the module box 21 and is kept in this position by tension springs 47. It can be opened, i.e. be swung down, by energizing solenoids 49 mounted at each side of the module box.

The bottom lid 27 can possibly, for increased security, be locked in a swung-up, closed position by some locking mechanism, not shown, that for example can include a solenoid having an armature coupled to a latch bolt, not shown, acting against the rear inner edge of the bottom lid.

Inside the pulling-in rolls 35, 37 some device is provided that senses whether a mail item is being pulled in and it provides signals when a mail item arrives at and afterwards has passed through and left the pulling-in rolls. This device can be of optical type and can then include a suitable light source such as an IR-diode 51 mounted on the inner upper surface of the module box inside the upper pulling-in rolls and an optical switch 53 mounted so that it can receive light from the IR-diode and so that this light is cut off when a mail item is located between the pulling-in rolls. As illustrated, it can be mounted at the inner bottom surface of the module box 21, directly inside the lower pulling-in rolls 35.

Furthermore, in the module box, at its upper wall and at its innermost place, a camera 61 can be provided including suitable illumination for capturing pictures of mail item when it has been introduced into the box up to the rear wall thereof A weighing device 63 can be mounted at the bottom of the module box, in front of the lid 27.

A microprocessor 53 is connected to the key set 27, the display 9, the card reader 11, the receipt printer 15, the optical switch 53, the camera 61, the weighing device 63 and the driving units for the various electrically operated mechanical parts of the module 19, possibly through driver circuits, not shown. The microprocessor is connected to or includes a static, read and write memory 57 and it can also be connected to or include circuits 59 for mobile telephony communication or other remote communication.

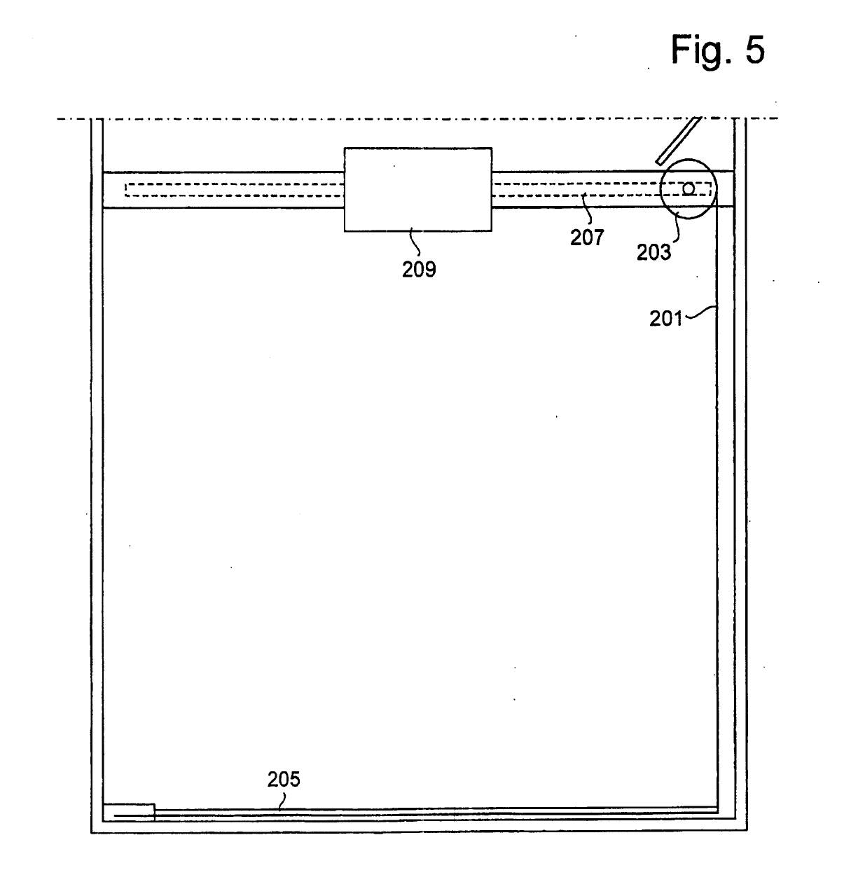

The function of the mail box will now be described with reference to the flow diagram of FIG. 4. The different steps are controlled by actions of the person who wants to put a mail item into the mail box and by different states of the electric and mechanical means of the mail box, for which signals informing on their states are transferred to the processor 55 and a multitude of which are controlled by signals therefrom. The display 9 shows in an inactive state some simple text including a message for identifying such as, “Enter card”, see step 101. A person who wants to mail an item, thereupon identifies himself. It can in the illustrated embodiment be made by first entering a readable card, such as an electronic card of type Smartcard, in the slot 13 of the card reader 11, see step 103. The card is read, the information read is transmitted to the microprocessor 55 that sends a signal so that a new text is displayed on the display, for example “Enter PIN-code”. Above the quick selection keys, in small type, the texts “error” and “cancel” be shown. The person thereupon enters a PIN-code on the key-set 7 and can then use the quick selection keys to correct already entered figures or terminate the entering operation, see step 105. The code is read, the information is transmitted to the microprocessor 55 and is checked by it. In the case of a card of type Smartcard the PIN-code can be checked directly against information accessed from the card. In other cases the information must be taken from some central unit, not shown, which can be performed using communication with some central unit, such as wireless communication provided by the mobile telephony circuits 59. If the entered code is decided to be incorrect by the processor, a new text is shown, such as “Incorrect PIN-code Try again”, see step 107. Thereafter, the person must repeat the entering of the PIN-code. The checking procedure is repeated. If a correct PIN-code has not been obtained after a predetermined number of trials, the card is blocked, se step 109.

If the processor 55 decides that a correct PIN-code has been entered, a new menu is shown on the display, see step 111. Then, in small type, above one of the quick selection keys 10 the text “terminate” is shown. In the menu shown alternatives are provided to see the balance which is associated with the card and for which information is stored on the card or is available in some other way, to select that the letter/letters is or are ESS-letters, i.e. registered letters, to indicate the number of letters, to enter text that is to be printed on the letter/letters, to perform the very posting of the letter/letters and to obtain more information about the menu system.

The person can select a desired menu line or terminate the procedure by pressing the suitable quick selection key 10. If the person selects to obtain more information, new text is shown on the display 9 and in small type, above the quick selection keys, the text “next” and “terminate”, respectively, is shown, see step 113. The person can feed more information text or terminate the displaying of information by pressing the respective quick selection key 10. In this latter case the display 9 returns to show the menu.

If the menu line for the balance is selected, see step 115, the microprocessor 55 retrieves information on the balance that is associated with the card and shows it on the display 9, see step 117. In small type above the quick selection keys the text “menu” and “cancel” are shown. The person can then terminate the very posting procedure by pressing the suitable quick selection key 10 or return to the menu by pressing the other quick selection key, in the latter case thus to the step 111.

If the menu line for ESS-letters is selected, se step 119, a new text is shown on the display 9 and the user can select the format of the mail item by pressing suitable keys in the key set 7, see steps 121, 123. Thereupon, again the menu is shown in step 111.

If the menu line for indicating the number of letters is selected, see step 125, a new text is shown on the display 9 and the user can in a step 107 select the number of mail items by pressing suitable keys in the key set 7. Thereupon again the menu in the step 111 is shown.

If the menu line for indicating text on letters is selected, see step 129, a new text is shown on the display 9 and the user can in a step 131 enter text by pressing suitable keys in the key set 7. However, the key set has only keys for figures but in this step alphanumerical character can be entered in the same way as is used for entering text for an SMS-message on a mobile telephone. Thereupon again the menu in the step 111 is shown.

If the menu line for posting a letter/letters is thereupon selected, see step 133, a new text is shown on the display 9 and the person can by pressing suitable keys in the key set 7 select between the alternatives that the mail item already is stamped, see step 135, that it will be manually stamped, see step 137, or be automatically stamped, see step 139. In the case where the letter/letters is/are to be manually stamped, thereupon text is shown for selecting the magnitude of the portage, see step 141, so that information thereof can be entered. After this information has been entered the corresponding amount is deducted, considering the number of mail items that in the case that no particular number has been indicated, due to the fact that the step 120 has not been selected previously, as standard value of one single mail item, from the balance associated with the card. After the steps 135, 139 and 141 all preparing steps have been made for the very posting, see step 143, in which letters are to be put into the box. Then a new text is shown, such as “Put n items into the box one after another with their front-sides turned upwards”, where n is the selected number of mail items.

The microprocessor 55 then sends signals to the locking device 32 in order that it will allow opening of the lid 5 and to the motor 33, whereupon the lid is swung upwards and leaves the opening of the module box 21 free. The pulling-in rolls 35, 37 are controlled to start rotating, the person introduces a mail item between them and the mail item passes into the box up to the inner rear wall thereof. The transport that the mail item is introduced and leaves the rolls is sensed by the optical switch 53. The mail item is weighed when it passes the weighing device 63 and the weighing device then transmits information of the weight of the mail item to the microprocessor 55. The mail item is photographed by the camera 61 when it reaches the rear wall of the box. Thereupon, the marking device 43 is activated and a marking is placed on the mail item. In a simple embodiment for example a multitude of lines of different lengths are placed along the same single straight at the upper edge of the mail item.

The marking or stamping placed on the item always includes information about the identity of the person who has put the letter into the box or strictly the person with which the card read together with entered PIN-code is associated. Furthermore, the marking includes information about the mail box so that it can be identified and in particular so that its geographical position appears from this information. Furthermore, the marking includes information of the postage paid in the case where the user selected the alternative Manual postage, see step 137, an entered and confirmed postage amount, step 151, an automatically determined postage, if the user has selected the alternative Automatic stamping, see step 139, and information on the type of the letter, such as that it is an ESS-letter/a registered letter. For automatic stamping, the microprocessor 55 calculates the correct postage based on the information about the weight of the mail item as obtained from the weighing device. The marking can also include some text entered by the user, see step 131. After the marking has been placed on the mail item, also information about the mail item is stored in the static memory 57.

Thereupon, the bottom lid 25 is opened by energizing the solenoids 49 and the mail item falls down into the collecting part of the mail box 1. In the normal case the lid 5 is thereafter closed and the pulling-in rolls 35, 37 finish rotating. If the user has indicated that a plurality of letters are to be mailed, however, the lid kept open for introducing the next letter. The lid 5 is closed after introducing the indicated number of letters.

Thereupon, if desired, in a step 145 a receipt for reception of the mail item/items can be printed by the receipt printer 15. The receipt can include information of time, mail box, postage, etc. The receipt can also include possible entered text, see step 131, and a picture in a reduced scale of the front side of the mail item/items obtained from the camera 61. Then, again the menu is shown in the step 111 during a short time period, for example 5 seconds, after which, if no new input is received, the system returns to its start state in step 101.

On the display 9, during the procedures, the texts “menu” and “cancel”, respectively, are shown above the quick selection keys 10 so that the person can terminate the post procedure or return to the menu.

On the user's card information can be provided about the maximal number of mail items that are allowed to be entered in the mail box at one occasion.

Instead of or as a supplement to storing information in the static memory 57 information can be transferred to a central database, not shown, through the mobile telephony circuits 59. This information can be used for checking the mail item, such as that it is transported in a correct way by automatically reading the marking placed on the mail item in different mail handling stations, and to provide information about the sender in the case where the mail item is lost or appears to have harmful or non-desired contents. Information about transported mail items can for example be stored centrally in a database in every country. This information for a mail item sent in one country and addressed to a receiver in another country can then be transferred from the database in the country in which the mail item has been mailed, to the database in the receiving country and possibly to databases in the countries through which the mail item has to be transported before it reaches the receiving country.

When the mail box is to be emptied by some person, such as by a person employed by the public postal services, such as in those cases where no transmission to a central unit is performed, this person can have all the information stored in the memory 57 transferred to his electronic card when it is introduced into the card reader 11 and the person has entered his PIN-code.

After the identity of a person has been determined, which in alternative, not shown embodiments can be made by reading personal characteristics, possibly supplemented with reading a personal code, the microprocessor can, if required or desirable, decide that the person has authority to put mail into the mail box by comparing the identity of the person to a list for example stored in the memory 57, the list including authorized identities or including a list of blocked accounts that for example can be centrally stored. If the person is decided not to be authorized the procedure is stopped, i.e. in the special case the lid 5 is not opened and the person is thus not allowed to put any mail into the box.

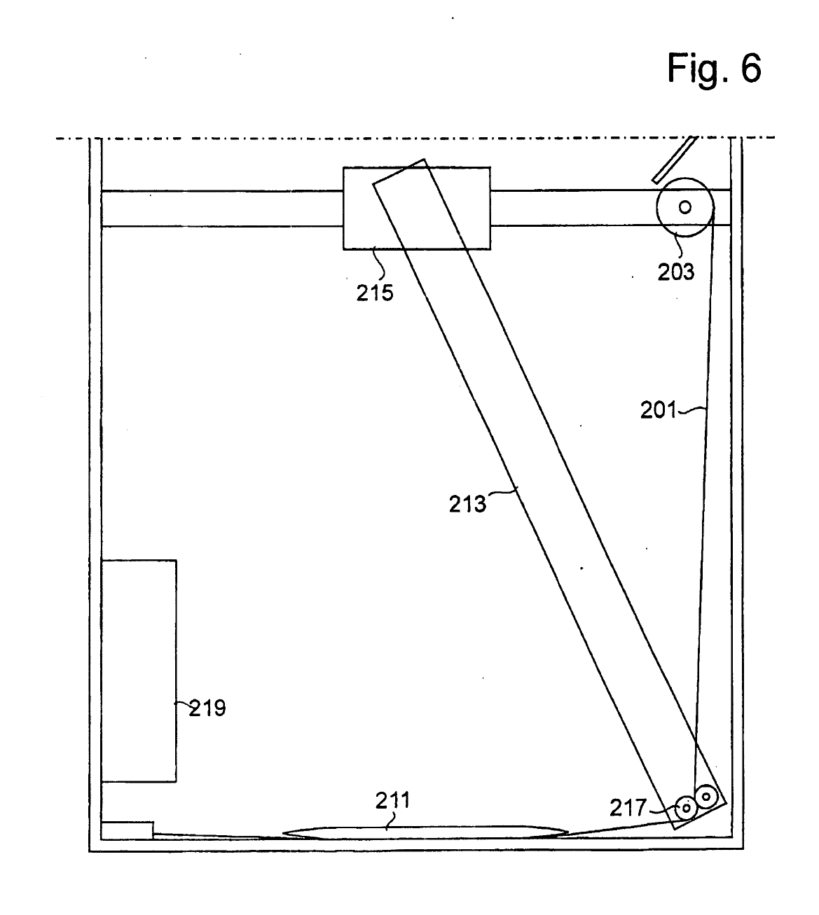

The collecting vessel below the module box 21 for receiving mailed items put into the box can be provided with a device for separating, by some sheet material such as plastic film, the mail items put into the box from each other. Thus, in FIG. 5 it is schematically shown how a plastic film 201 is rolled off from a roll 203 and with its free end is attached to the bottom of the vessel. A rigid paper sheet 205 or similar thing is initially placed on top of the film. After a letter has fallen down into the vessel, the plastic film is placed on top of the letter by displacing the roll 203 from one side of the vessel to its opposite side, using a mechanic guide and pulled by a motor 209. Alternatively the roll 203 can be geographically fixed such as illustrated in FIG. 6. In this case, the plastic film does not have to start with a rigid paper sheet but is put on top of a letter 211 by a swing arm 213 operated by a motor 215 and provided with rolls 217. Each letter receives in this case a first top plastic film layer that is sealed by a device 219 and on top thereof a second plastic film when the swing returns to the position shown in FIG. 6.

It should be understood herein and in the claims hereof that such terms as “upper”, “top”, “lower”, “bottom”, “upwardly”, “downwordly”, “rear”, “lateral” and the like have been used for illustration purposes only, in order to provide a clear and understandable description and claiming of the invention. Such terms are not in any way to be construed as limiting, because the devices of invention are omni-directional in use as can be understood by their various uses in different application fields.

While specific embodiments of the invention have been illustrated and described herein, it is realized that numerous additional advantages, modifications and changes will readily occur to those skilled in the art. Therefore, the invention in its broader aspects is not limited to the specific details, representative devices and illustrated examples shown and described herein. Accordingly, various modifications may be made without departing from the spirit or scope of the general inventive concept as defined by the appended claims and their equivalents. It is therefore to be understood that the appended claims are intended to cover all such modifications and changes as fall within a true spirit and scope of the invention.

1. A mail box for receiving items of mail for mailing/transport to an addressee including an introduction opening, an openable lid at the introduction opening and a pulling-in device for pulling a device into the mail box, comprising:
a device for registering the identity of a person who is to introduce an item of mail into the mail box, and/or,
a marking device for marking an item of mail introduced into the mail box with information about the identity of the person who has introduced the item of mail into the mail box.

2. A mail box according to claim 1, wherein the marking device is arranged to place the marking so that it includes an identification of the mail box, in particular information of the geographical position of the mail box.

3. A mail box according to claim 1, wherein the device for registering the identity of a person who is to introduce an item of mail into the mail box is arranged to determine whether the person is authorized to introduce items of mail into the mail box.

4. A mail box according to claim 3, wherein the device for registering the identity includes a reader for cards such as electronics card and/or a device such as a keys set for entering characters, such as for entering a personal code or PIN-code.

5. A mail box according to claim 1, comprising a lock mechanism for the lid so that the lid only can be opened after the identity of the person has been registered and possibly after it has been decided that the person is authorized to introduce items of mail.

6. A mail box according to claim 1, comprising a device for entering information about the postage which is to be paid for an item of mail, the marking device arranged to place the marking so that it includes information of paid postage.

7. A mail box according to claim 1, comprising a device for entering information that an item of mail is of a particular kind, such as that the item of mail is an ESS-item of mail or a registered item of mail, the marking device arranged to place the marking so that it includes information on the kind to which the item of mail belongs.

8. A mail box according to claim 1, comprising a device for providing a confirmation to the person who has introduced an item of mail, in particular a device for printing a receipt, the confirmation including information about the identity of the person, the mail box and time for introducing and possibly information of paid postage and possibly information of whether the item of mail is of a particular type.
